(19) United States
(12) Patent Application Publication
(10) Pub. No.: US 2010/0149673 A1
(43) Pub. Date: Jun. 17, 2010

(54) METHOD FOR TESTNG MOLD STRUCTURE, MOLD STRUCTURE, AND MAGNETIC RECORDING MEDIUM

(75) Inventors: Kenji ICHIKAWA, Kanagawa (JP); Atsushi TATSUGAWA, Kanagawa (JP); Toshihiro USA, Kanagawa (JP)

Correspondence Address: YOUNG & THOMPSON, 209 Madison Street, Suite 500, Alexandria, VA, 22314, US

(73) Assignee: FUJIFILM CORPORATION, Tokyo (JP)

(21) Appl. No.: 12/636,145

(22) Filed: Dec. 11, 2009

(30) Foreign Application Priority Data
Dec. 12, 2008 (JP) 2008-316938

(51) Int. Cl. G11B 27/36

(52) U.S. Cl. 360/31; G9B/27.052

(57) ABSTRACT

A method for testing a mold structure including magnetically transferring a magnetic signal according to a concavo-convex pattern for a servo area in a mold structure to a perpendicular magnetic recording medium; electrically reproducing ≧50 tracks of the magnetic signal of servo data transferred onto the perpendicular magnetic recording medium using a magnetic head to obtain a reproduction signal; and calculating a pattern drawing accuracy radially from the reproduction signal to evaluate a performance of the mold structure including a disc-shaped base material; and the concavo-convex pattern for the servo area and a concavo-convex pattern for a data area formed on a base material surface following a desired design pattern. The concavo-convex patterns for the servo area are aligned in the radial direction of the base material, and the concavo-convex pattern for the data area are aligned in the circumferential direction between the concavo-convex patterns for the servo area.

### BACKGROUND OF THE INVENTION

1. Field of the Invention

The present invention relates to a method for testing a mold structure provided with a concavo-convex pattern which is formed on a surface thereof according to a desired design pattern, and a mold structure, and a magnetic recording medium.

2. Description of the Related Art

As a magnetic recording medium capable of increasing recording density, discrete track media (DTM) and bit patterned media (BPM) have been attracted attention.

The discrete track media include nonmagnetic areas between adjacent tracks, so that each track is magnetically divided. Thus, even though track intervals are narrowed to increase recording density, magnetic interference between adjacent tracks (crosstalk) can be reduced owing to the nonmagnetic area.

The bit patterned media have bits for recording signals which are arranged regularly at a certain distance. Since each bit is independent, the bit patterned media are not easily influenced by heat fluctuation even though bit intervals are narrowed so as to increase recording density.

These discrete track media and bit patterned media have concavo-convex patterns on the surfaces thereof. The magnetic recording medium having a concavo-convex pattern on the surface is produced using a mold structure having a concavo-convex pattern which is a inversion of the concavo-convex pattern of the magnetic recording medium (see Japanese Patent Application Laid-Open (JP-A) No. 2004-221465). The mold structure is produced using an original master having a concavo-convex pattern formed according to a predetermined design pattern using an electron beam (EB) drawing device or the like.

Recently, mold structures having lines of 20 nm in width have been developed. There are very few methods for evaluating accuracy of such ultrafine pattern. The pattern accuracy is came out when the resulted magnetic recording medium, to which nanoimprint lithography (NIL) is performed and then etching is performed, is actually set in a spin-stand or HDD. Therefore, since the correction of the inaccurate pattern takes a long time and the pattern accuracy is strongly affected by the NIL or the etching process, a shape drawn by an EB drawing may be deformed in the resulted magnetic recording medium.

An alignment of finely processed servo pattern is generally evaluated by a device such as CD-SEM, AFM or the like. In this case, as shown in FIG. 1, when the pattern in shifted by 30 nm in the radial direction, the pattern can be evaluated by visually observing a picture of scanning electron microscope (SEM). However, the shift by 15 nm in the radial direction as shown in FIG. 2, and the shift by 3 nm in the radial direction as shown in FIG. 3 are hard to identify by the visual observation of the SEM pictures. Since it is hard to identify the direction of the shift of the pattern by 15 nm or less in the radial direction, the pattern accuracy needs to be evaluated using a magnetic head.

Examples of the shift of the pattern in the radial direction by an EB drawing include shift between drawing points caused by beam deflection of the EB drawing device and shift caused from a feed per revolution of a stage upon EB drawing. It is necessary to clarify these causes and to decrease the shift.

In the specifications, FIG. 5 is a SEM picture in which a feed per revolution of a stage upon EB drawing is optimally adjusted. FIG. 4 is a SEM picture in which the feed per revolution of the stage upon EB drawing is not adjusted. In FIG. 4, lines are formed in the radial direction at constant intervals due to the feed per revolution of the stage, while no line can be seen in FIG. 5.

In the case where the shift of the pattern in the radial direction by the EB drawing is 15 nm or less, the accuracy of the pattern cannot be sufficiently evaluated by observing the pattern with electron beam or by evaluating a part of the pattern using an AFM device. Thus, it is effective to increase the population to be evaluated using the magnetic head.

In order to secure the accuracy (linearity) of a servo pattern in the radial direction, it is necessary to adjust connection conditions by the EB drawing device. The connection conditions are adjusted by an evaluation method of magnetic transfer.

As such method for testing a mold structure using the magnetic transfer method, the inventors of the present invention have proposed a method for evaluating tracks of an entire substrate, lack of pattern and the like (Japanese Patent Application Laid-Open (JP-A) No. 2009-176373). However, according to this method, the track of a concavo-convex pattern for a servo area is obtained from a reproduction signal, and circularity of the mold structure is evaluated from the track, thus, it is hard to evaluate the accuracy (linearity) of the servo pattern in the radial direction by fine adjustment of the parameter of the EB drawing. Thus, currently, further improvement and development of the method is demanded.

### BRIEF SUMMARY OF THE INVENTION

An object of the present invention is to provide a method for testing a mold structure, which can rapidly and accurately evaluate accuracy (linearity) of a servo pattern in the radial direction, and to provide a mold structure, and a magnetic recording medium.

Means for solving the problems are as follows.
<1> A method for testing a mold structure including: magnetically transferring a magnetic signal according to a concavo-convex pattern for a servo area in a mold structure to a perpendicular magnetic recording medium; electrically reproducing 50 tracks or more of the magnetic signal of servo data transferred onto the perpendicular magnetic recording medium using a magnetic head so as to obtain a reproduction signal; and calculating a pattern drawing accuracy in the radial direction from the reproduction signal so as to evaluate a performance of the mold structure, wherein the mold structure includes a disc-shaped base material and the concavo-convex pattern for the servo area and a concavo-convex pattern for a data area formed on a surface of the base material according to a desired design pattern, and wherein the concavo-convex pattern for the servo area are aligned in the radial direction of the base material, and the concavo-convex pattern for the data area are aligned in the circumferential direction between the concavo-convex patterns for the servo area.
<2> The method for testing a mold structure according to <1>, wherein the pattern drawing accuracy in the radial direction is 7 nm or less.
<3> The method for testing a mold structure according to <1>, wherein a head width of the magnetic head is 50% or more to less than 100% of the track width.
<4> The method for testing a mold structure according to <1>, wherein when the pattern drawing accuracy in the radial direction is more than 7 nm, any of a beam deflection and a feed per revolution of a stage is adjusted in an electron beam drawing device in production of the mold structure.
<5> A mold structure, including a disc-shaped base material; and a concavo-convex pattern for a servo area and a concavo-convex pattern for a data area formed on a surface of the base material according to a desired design pattern, wherein the concavo-convex pattern for the servo area are aligned in the radial direction of the base material, and the concavo-convex pattern for the data area are aligned in the circumferential direction between the concavo-convex patterns for the servo area, and wherein the mold structure is tested by a method for testing a mold structure, the method including: magnetically transferring a magnetic signal according to the concavo-convex pattern for the servo area in the mold structure to a perpendicular magnetic recording medium; electrically reproducing 50 tracks or more of the magnetic signal of servo data transferred onto the perpendicular magnetic recording medium using a magnetic head so as to obtain a reproduction signal; and

calculating a pattern drawing accuracy in the radial direction from the reproduction signal so as to evaluate a performance of the mold structure.
<6> The mold structure according to <5>, wherein the pattern drawing accuracy in the radial direction is 7 nm or less.
<7> A magnetic recording medium produced by using a mold structure tested by a method for testing a mold structure, wherein the mold structure includes: a disc-shaped base material; and a concavo-convex pattern for a servo area and a concavo-convex pattern for a data area formed on a surface of the base material according to a desired design pattern, and wherein the concavo-convex pattern for the servo area are aligned in the radial direction of the base material, and the concavo-convex pattern for the data area are aligned in the circumferential direction between the concavo-convex patterns for the servo area, and wherein the method for testing a mold structure includes: magnetically transferring a magnetic signal according to the concavo-convex pattern for the servo area in the mold structure to a perpendicular magnetic recording medium; electrically reproducing 50 tracks or more of the magnetic signal of servo data transferred onto the perpendicular magnetic recording medium using a magnetic head so as to obtain a reproduction signal; and calculating a pattern drawing accuracy in the radial direction from the reproduction signal so as to evaluate a performance of the mold structure.

The present invention can solve the conventional problems and provide a method for testing a mold structure, which can rapidly and accurately evaluate accuracy (linearity) of a servo pattern in the radial direction, and to provide a mold structure, and a magnetic recording medium.

### BRIEF DESCRIPTION OF THE DRAWINGS

FIG. 1 is a scanning electron microscope (SEM) picture showing a state in which a pattern is shifted by 5 nm in the radial direction.

FIG. 2 is a scanning electron microscope (SEM) picture showing a state in which a pattern is shifted by 2 nm in the radial direction.

FIG. 3 is a scanning electron microscope (SEM) picture showing a state in which a pattern is shifted by 0.5 nm in the radial direction.

FIG. 4 is a SEM picture of a servo pattern in which a feed per revolution of a stage of an EB drawing device is not adjusted.

FIG. 5 is a SEM picture of a servo pattern in which the feed per revolution of the stage of the EB drawing device is optimally adjusted.

FIG. 6 is a flow chart showing a procedure of a method for testing a mold structure.

FIG. 7 is an explanatory view specifically showing a feedback to a mold structure producing step in the method for testing a mold structure.

FIG. 8 is a plan view schematically showing a disc-shaped mold structure.

FIG. 9 is a plan view schematically showing a partial constitution of the mold structure used for producing a discrete track medium (DTM).

FIG. 10 is a plan view schematically showing a partial constitution of a mold structure used for producing a bit patterned medium (BPM).

FIGS. 11A and 11B are cross sectional views showing a method for producing a mold structure.

FIG. 12A shows an initially magnetizing step in a magnetic transfer method with respect to a perpendicular magnetic recording medium.

FIG. 12B shows a closely attaching step in the magnetic transfer method with respect to a perpendicular magnetic recording medium.

FIG. 12C shows a magnetic transfer step in the magnetic transfer method with respect to a perpendicular magnetic recording medium.

FIG. 13 shows a schematic diagram showing an example of a testing device for the method for testing a mold structure of the present invention.

FIG. 14 is an explanatory view showing a method for producing a magnetic recording medium using the mold structure of the present invention.

FIG. 15 shows a pattern used to perform EB drawing in an original plate in Examples.

FIG. 16 shows a method for drawing a pattern in Examples.

FIG. 17 is a graph showing a relation between a feed per revolution of BIT-FINDER and a PES value.

FIG. 18 is a graph showing a relation between an EB parameter and errors between track intervals.

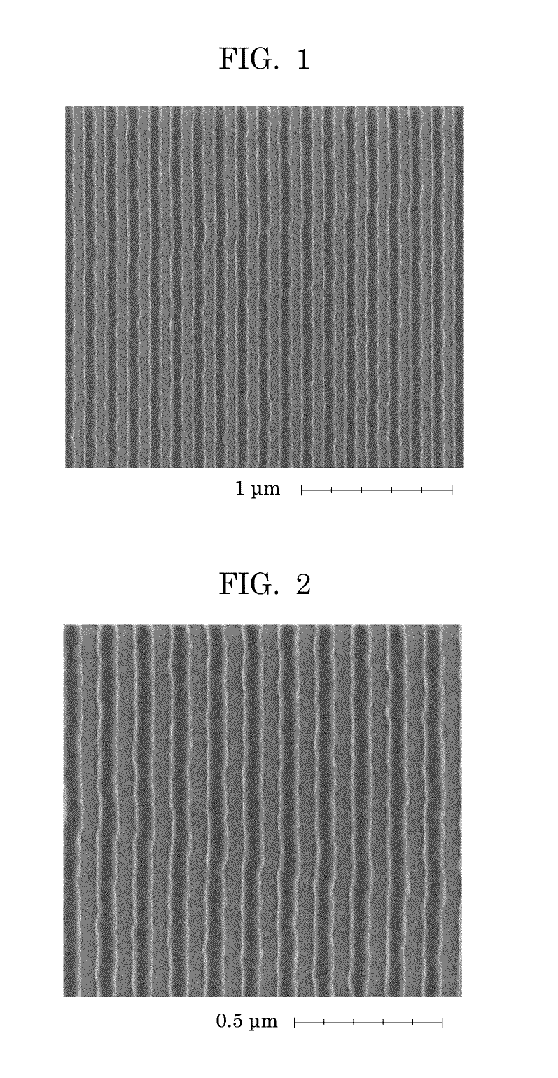

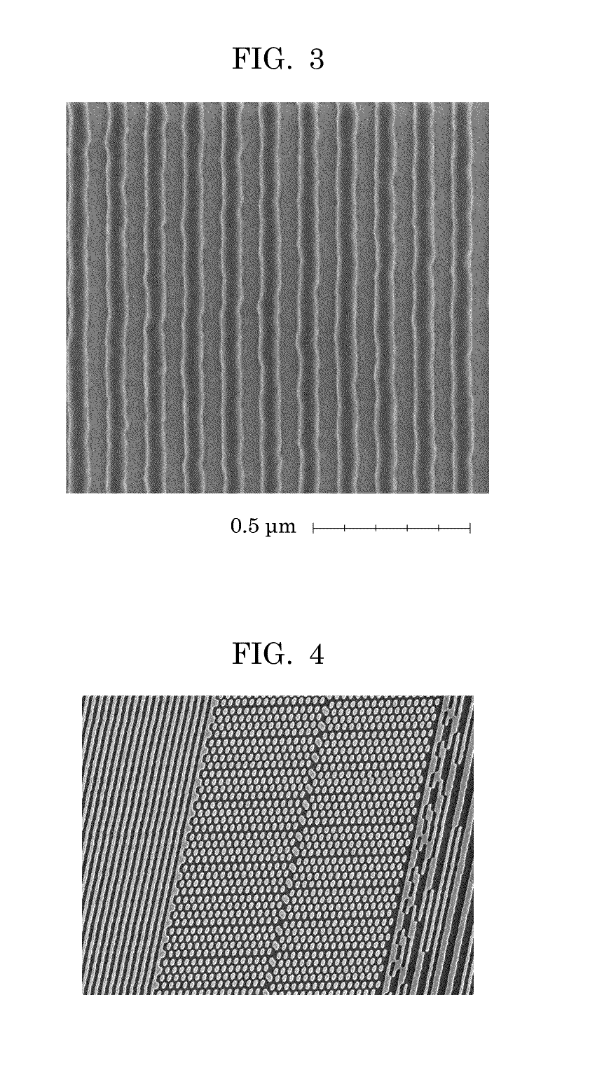

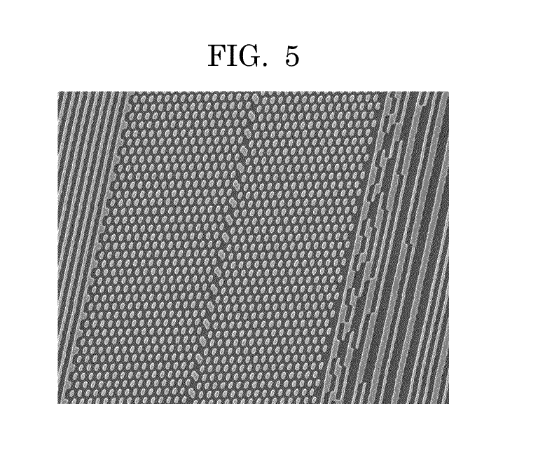

### DETAILED DESCRIPTION OF THE INVENTION

### (Method for Testing Mold Structure)

A method for testing a mold structure of the present invention is a method for testing a disc-shaped mold structure having a convexo-concave pattern formed on a surface of the base material according to a desired design pattern, and the method includes a magnetic transfer step, a reproduction signal obtaining step, and an evaluating step, and further includes a mold structure producing step, and other steps as necessary.

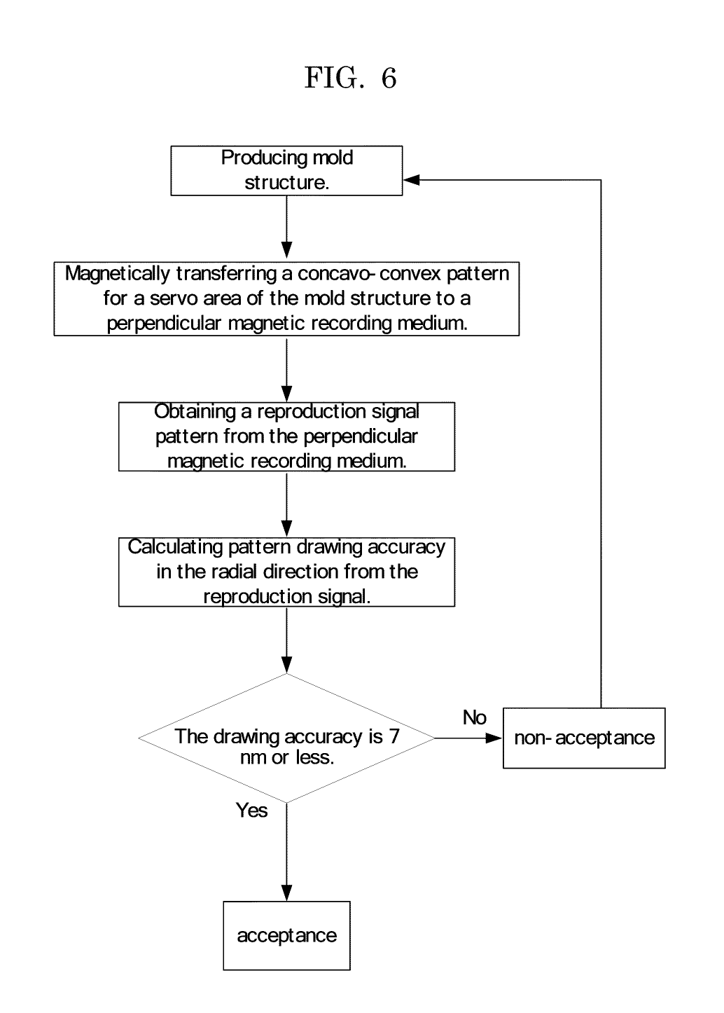

FIG. 6 is a flow chart showing a procedure of the method for testing a mold structure.

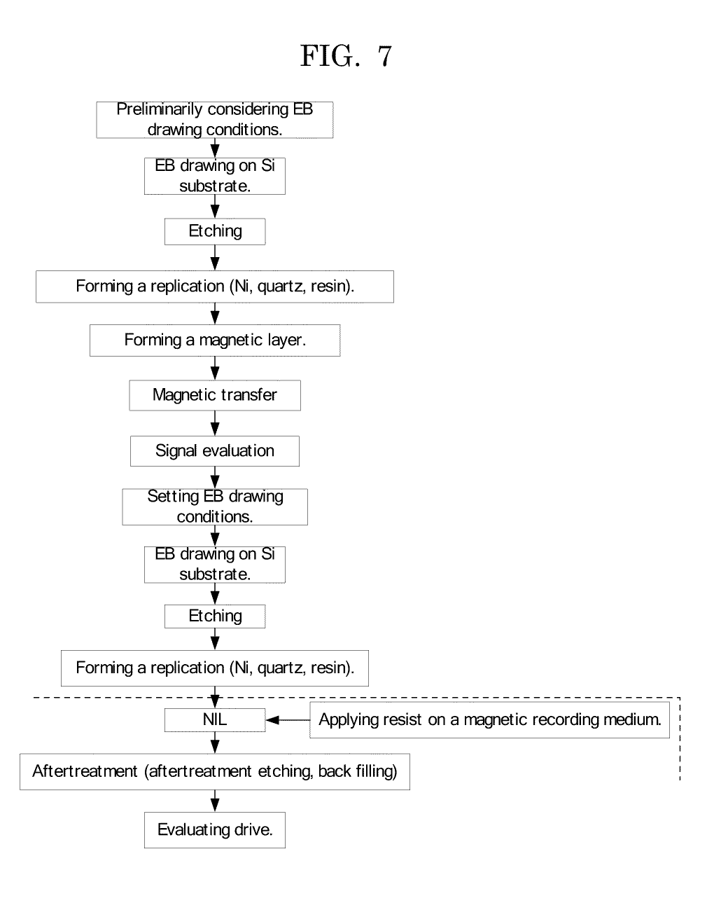

A produced mold structure is subjected to the magnetic transfer step, the reproduction signal obtaining step, and the evaluating step, so as to obtain a pattern drawing accuracy (linearity) in the radial direction. The linearity of 7 nm or less is judged as “acceptance”. On the other hand, the linearity of more than 7 nm is judged as “non-acceptance”. Then, as shown in FIG. 7, in a step of drawing a pattern in an Si substrate by an electron beam (EB) drawing device upon production of the mold structure, beam deflection or a feed per revolution of a stage is adjusted. Hereinafter, each step will be specifically described.

### <Mold Structure Producing Step>

A mold structure, which is an object to be tested by the method for testing a mold structure of the present invention, include a disc-shaped base material, a concavo-convex pattern for a servo area and a concavo-convex pattern for a data area formed on a surface of the base material according to a desired design pattern, wherein the concavo-convex pattern for the servo area are aligned in the radial direction of the base material, and the concavo-convex pattern for the data area are aligned in the circumferential direction between the concavo-convex patterns for the servo area, and further includes other members as necessary.

### [Mold Structure]

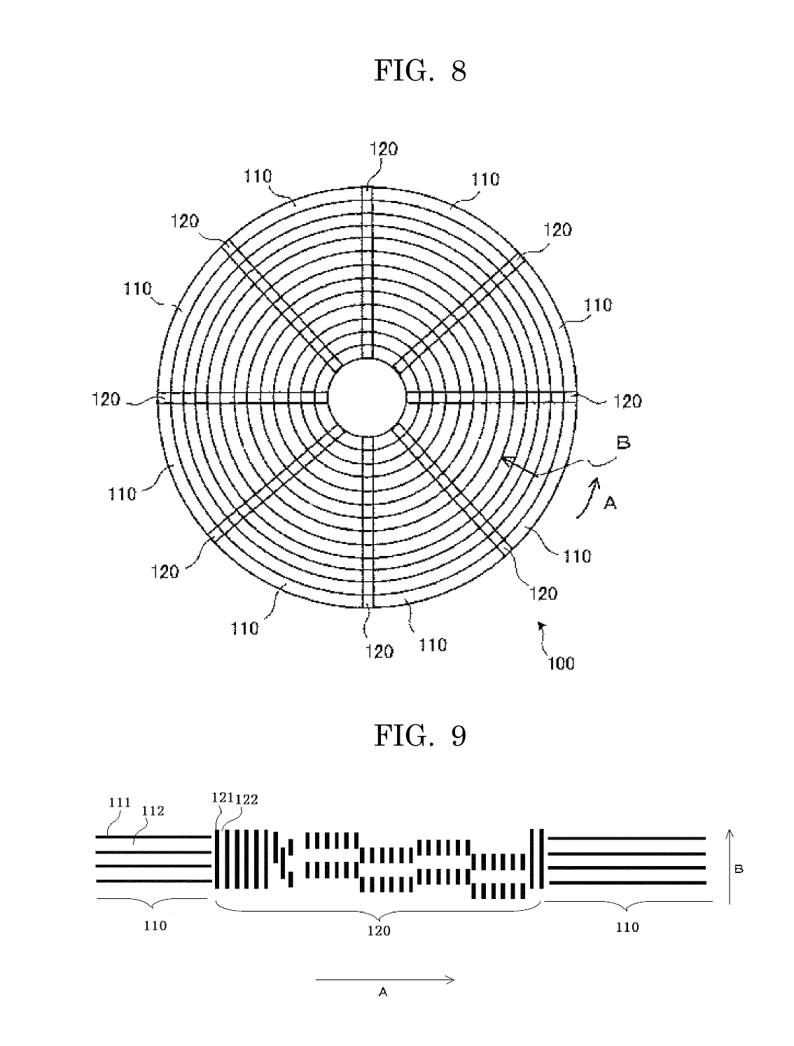

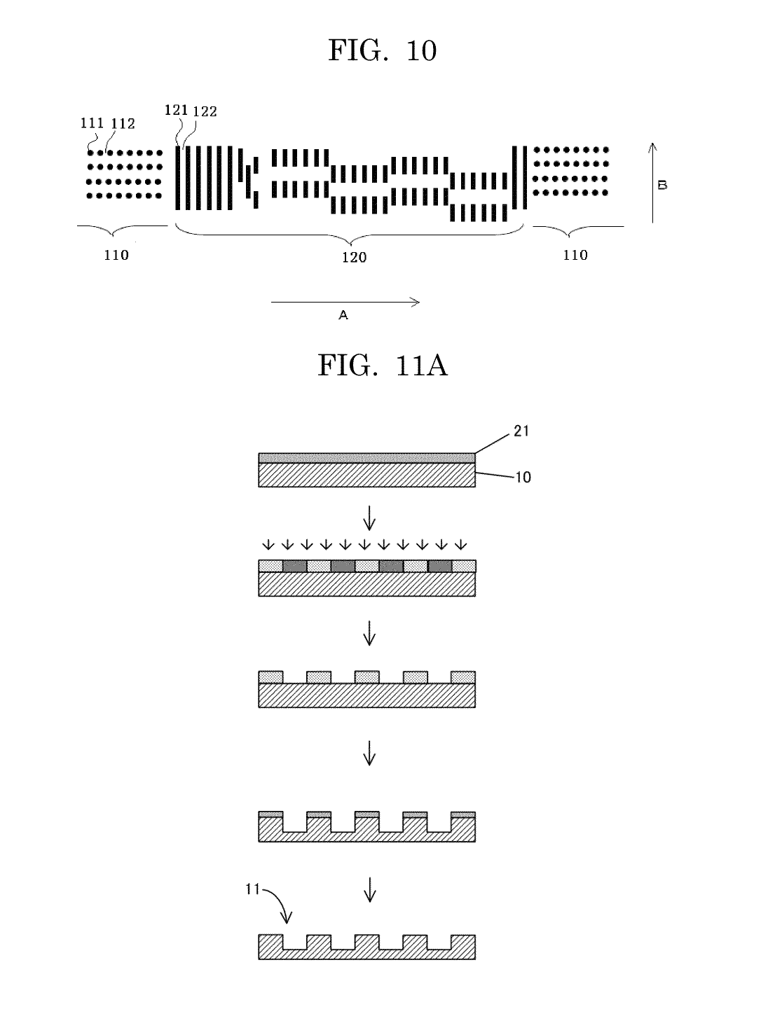

FIG. 8 is a plan view schematically showing a mold structure to be tested by the method for testing a mold structure of the present invention. FIG. 9 is a plan view schematically showing a partial constitution of a mold structure used for producing a discrete track medium (DTM). FIG. 10 is a plan view schematically showing a partial constitution of a mold structure used for producing a bit patterned medium.

As shown in FIGS. 8, 9 and 10, a mold structure 100 is used to produce a magnetic recording medium, and the mold structure 100 have a concavo-convex pattern 110 corresponding to a data area of the magnetic recording medium and a concavo-convex pattern 120 corresponding to a servo area of the magnetic recording medium.

### —Concavo-Convex Pattern Corresponding to Data Area—

As shown in FIG. 9, the concavo-convex pattern 110 corresponding to a data area (concavo-convex pattern for a data area) includes a concave portion 112 corresponding to a magnetic layer of a magnetic recording medium and a convex portion 111 corresponding to a nonmagnetic layer of a magnetic recording medium.

As shown in FIG. 10, the concavo-convex pattern 110 corresponding to a data area (concavo-convex pattern for a data area) includes a concave portion 111 corresponding to the magnetic layer of a magnetic recording medium and a convex portion 112 corresponding to the nonmagnetic layer of the magnetic recording medium.

Here, the concavo-convex pattern 110 corresponding to the data area is the concavo-convex pattern formed in the circumferential direction A of the mold structure 100 (FIG. 9), or the concavo-convex pattern in which a plurality of bits are arranged (FIG. 10).

### —Concavo-Convex Pattern Corresponding to Servo Area—

As shown in FIG. 9, the concavo-convex pattern 120 corresponding to a servo area (concavo-convex pattern for a servo area) includes a convex portion 121 corresponding to the nonmagnetic layer of the magnetic recording medium and a concave portion 122 corresponding to the magnetic layer of the magnetic recording medium, wherein the concavo-convex pattern is formed in the radial direction B perpendicular to the circumferential direction A of the mold structure 100.

As shown in FIG. 10, the concavo-convex pattern 120 corresponding to a servo area (concavo-convex pattern for a servo area) includes a convex portion 121 corresponding to the nonmagnetic layer of the magnetic recording medium and a concave portion 122 corresponding to the magnetic layer of the magnetic recording medium, wherein the concavo-convex pattern is formed in the radial direction B perpendicular to the circumferential direction A of the mold structure 100.

The concavo-convex pattern 120 for a servo area is aligned radially from the center of the disc-shaped mold structure 100 to the outside.

### —Other Members—

Other members are not particularly limited as long as they do not impair the effect of the present invention, and may be suitably selected according to the purpose. Examples of other members include a mold surface layer which has a separating function with respect to an imprint resist layer, and a carbon film attached as a protective layer.

### [Method for Producing Mold Structure]

Hereinafter, an example of a method for producing a mold structure 100 of the present invention will be explained with reference to the drawings. However, the mold structure 100 of the present invention may be produced by a method other than the method described below.

### —Original Master Producing Step—

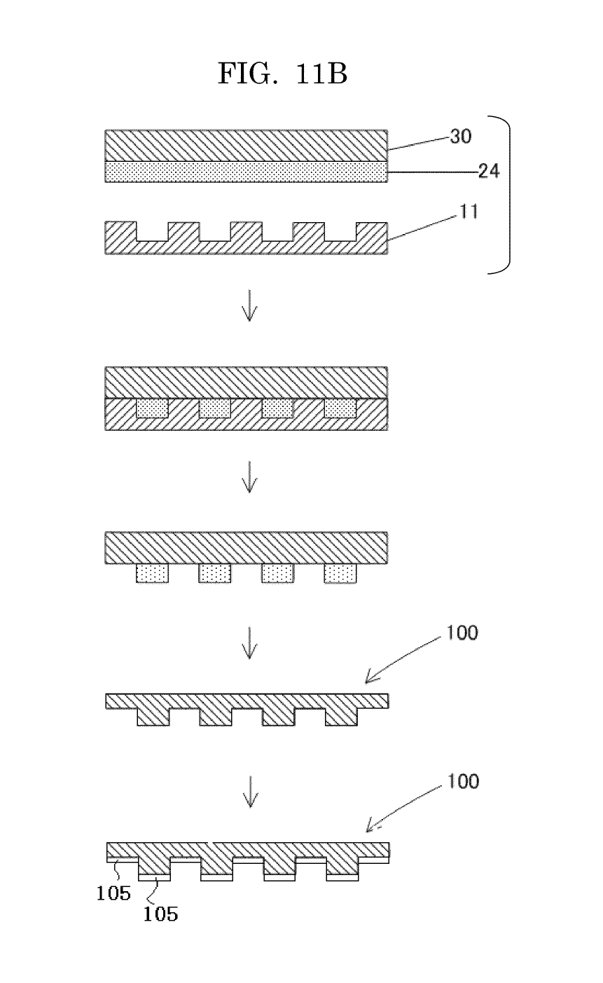

FIGS. 11A and 11B are respectively cross sectional views showing a method for producing the mold structure 100. As shown in FIG. 11A, firstly an electron beam resist liquid for a magnetic recording medium is applied over a silicon (Si) substrate 10 by spin coating so as to form an electron beam resist layer 21.

After that, while the Si substrate 10 is being rotated, an electron beam modulated correspondingly to a servo signal is applied onto the Si substrate 10 so as to form a predetermined pattern on the substantially entire surface of the electron beam resist layer 21; for example, a pattern, which corresponds to the servo signal and that linearly extends in the radial direction from the rotational center in each track, is exposed at portions corresponding to frames on the circumference.

Subsequently, the electron beam resist layer 21 is developed, the exposed portions are removed therefrom, and then selective etching was performed by reactive ion etching (RIE) or the like with the pattern of the electron beam resist layer 21, from which the exposed portions have been removed, serving as a mask, so as to obtain an original master 11 (mold original master) having a concavo-convex pattern.

### —Mold Structure Producing Step—

Next, as shown in FIG. 11B, the original master 11 is pressed against a quartz substrate 30 that is a substrate to be processed, whose one surface is covered with an imprint resist layer 24 formed by applying an imprint resist solution containing a photocurable resin or the like, and the concavo-convex pattern formed on the original master 11 is thus transferred onto the imprint resist layer 24.

Here, the material for the substrate to be processed is not particularly limited as long as it transmits light and has the strength necessary for it to function as a mold structure and may be suitably selected according to the purpose. Examples thereof include quartz (SiO₂).

The specific meaning of the expression “transmits light” is that the imprint resist is sufficiently cured when light is applied in such a manner as to enter one surface of the substrate to be processed and exit the other surface thereof covered with the imprint resist layer, and that the light transmittance from the one surface to the other surface is 50% or greater.

The specific meaning of the expression “has the strength necessary for it to function as a mold structure” is such strength as enables the material to withstand the pressurization when the master plate is pressed against the imprint resist layer formed on the substrate of the magnetic recording medium at 4 kgf/cm² in average surface pressure.

### —Curing Step—

Thereafter, the transferred pattern is cured by irradiating the imprint resist layer 24 with an ultraviolet ray or the like.

### —Pattern Forming Step—

Subsequently, selective etching is carried out by RIE or the like, with the transferred pattern serving as a mask, to obtain the mold structure 100, in which a concavo-convex pattern is formed.

Note that the method for producing the above mentioned mold structure 100 is nanoimprint lithography (NIL) using ultraviolet ray, however the method is not limited thereto, and may be nanoimprint lithography (NIL) using heat in which an Ni conductive layer is provided on the original master 11 having a convexo-concave pattern, followed by electroforming with Ni and separating the Ni conductive layer from the original master 11 to thereby obtain an Ni mold.

### —Magnetic Layer Forming Step—

A magnetic layer 105 composed of Fe₇₀Co₃₀ is provided as necessary by sputtering on a surface of the mold structure 100 obtained as described above. The magnetic layer 105 is formed to have a thickness of 20 nm. Note that layers such as a protective layer, a lubricant layer, etc. may be further provided on the magnetic layer 105 in the magnetic layer forming step. When the mold structure 100 is the above mentioned Ni mold, magnetic transfer can be performed without providing the magnetic layer 105 in the above mentioned magnetic layer forming step. On the other hand, when the mold structure 100 is a nonmagnetic mold, magnetic transfer cannot be performed without providing the magnetic layer 105 in the above mentioned magnetic layer forming step.

As described above, the mold structure 100 is prepared, and by the method for testing a mold structure of the present invention, the pattern drawing accuracy (linearity) in the radial direction and whether or not the deformation such as lacking, warping, etc. of the convexo-concave pattern of the mold structure are tested.

Thus, the mold structure which serves as an object to be tested by the method for testing a mold structure of the present invention is described, but an object to be tested by the method for testing a mold structure of the present invention is not limited to the mold structure 100, and may be an original master 11 used when the mold structure 100 is produced. When the original master 11 is a plate onto which magnetic transfer cannot be directly performed, such as an Si original plate, a magnetic layer is provided thereon in the same manner as in the above mentioned magnetic layer forming step.

### <Magnetic Transfer Step>

The magnetic transfer step is a step of magnetically transferring a magnetic signal to a perpendicular magnetic recording medium, corresponding to the convexo-concave pattern for the servo area of the mold structure.

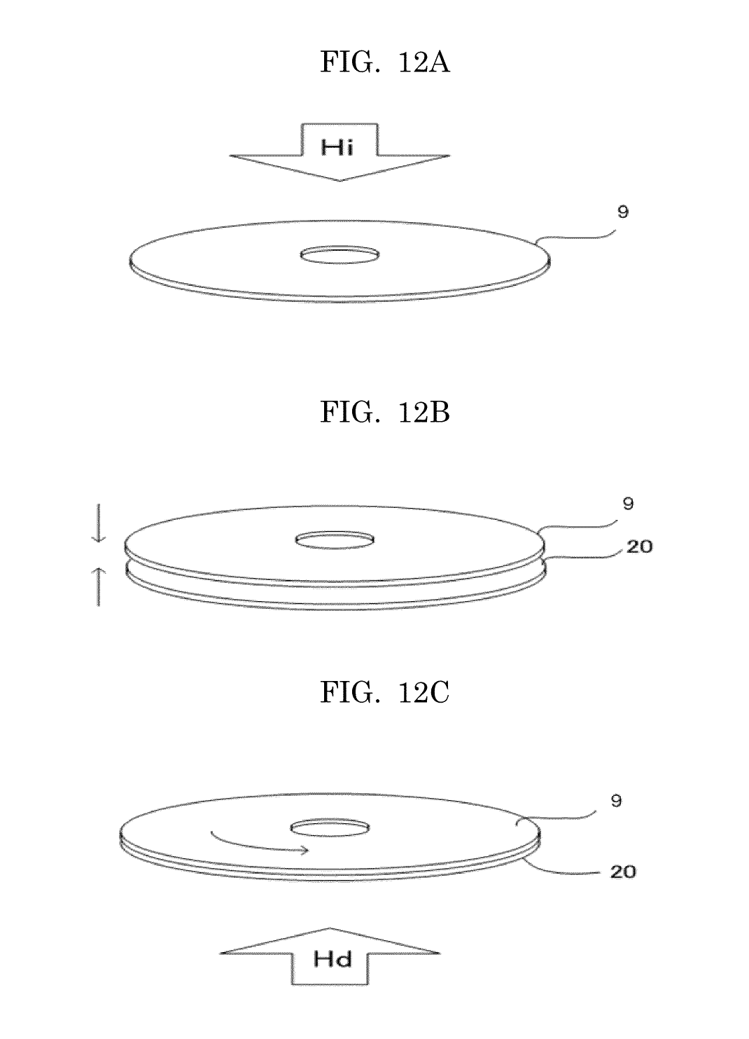

Here, the magnetic transfer step of perpendicular magnetic recording will be described with reference to FIGS. 12A to 12C. FIGS. 12A to 12C are explanatory views showing steps of the magnetic transfer method of the perpendicular magnetic recording. In FIGS. 12A to 12C, 9 denotes a slave disk (equivalent to a perpendicular magnetic recording medium) as a magnetic disk to be transferred, and 20 denotes a master disk as a magnetic transfer master.

As shown in FIG. 12A, a DC magnetic field Hi is perpendicularly applied to a flat surface of the slave disk 9, so as to initially magnetize the slave disk 9 (an initially magnetizing step).

After the initially magnetizing step, as shown in FIG. 12B, the master disk 20 is closely attached to the slave disk 9 which has been initially magnetized (a closely attaching step).

Moreover, after the closely attaching step, as shown in FIG. 12C, a magnetic field Hd whose direction is opposite to the DC magnetic field Hi is applied to the slave disk 9 and the master disk 20, which are closely attached to each other, so that the convexo-concave pattern is magnetically transferred on the slave disk 9 (magnetic transfer step).

### <Reproduction Signal Obtaining Step>

The reproduction signal obtaining step is a step of electrically reproducing 50 tracks or more of a magnetic signal of servo data transferred onto the perpendicular magnetic recording medium using a magnetic head so as to obtain a reproduction signal.

When the reproduction signal is less than 50 tracks, it may be difficult to detect variation occurred over a long period in the radial direction depending on the device accuracy.

The magnetic head is not particularly limited and may be suitably selected according to the purpose.

The magnetic head preferably has a head width of 50% or more to less than 100% of a track width. When the head width of the magnetic head is 100% or more of the track width, signal is negated by information of adjacent tracks, and position information from the signal cannot be calculated.

### <Evaluating Step>

The evaluating step is a step of calculating a pattern drawing accuracy in the radial direction from the reproduced signal so as to evaluate a performance of the mold structure.

The pattern drawing accuracy in the radial direction is also referred to as linearity, and means that adjacent track intervals are arranged at regular intervals. It is preferably 7 nm or less, and more preferably 3 nm to 6 nm. When the pattern drawing accuracy is more than 7 nm, 10% or more of the track width changes. Thus, alignment accuracy is insufficient.

In the specifications, the pattern drawing accuracy (linearity) in the radial direction is obtained as follows.

An electron beam resist is applied onto a disc-shaped Si wafer (original plate) of 8 inches in diameter by spin coating so as to form a resist layer. On the resist layer formed over the Si original plate, a servo pattern including a servo address area and a burst area is drawn under several conditions by an EB drawing device, and by using the condition of the least shift of track intervals observed by SEM as a standard, the pattern drawing accuracy in the radial direction is adjusted. By using the adjusted pattern as a standard, each pattern is drawn at a feed per revolution of a stage adjusted in the range from −6 to +6 of the EB drawing device so as to produce each original master having a pattern.

Next, each pattern of the original master is replicated by Ni electroforming to obtain a mold structure, and a magnetic layer is provided on the mold structure, and then magnetic information is magnetically transferred to a perpendicular magnetic recording medium by the magnetic transfer method.

The magnetic information transferred to the perpendicular magnetic recording medium is obtained in such a manner that 50 tracks or more of the magnetic signal of servo data transferred onto the perpendicular magnetic recording medium is electrically reproduced in a pitch of less than 1 track (Tr) by BIT-FINDER (manufactured by IMES Co., Ltd.) using a magnetic head (having a reading head width of 80 nm) so as to obtain a reproduction signal.

From the obtained date, a Position Error Signal (PES) value is calculated every servo frame, and a difference of the PES value calculated in the radial direction with respect to the feed per revolution of a piezoelectric stage of the BIT-FINDER (manufactured by IMES Co., Ltd.) is obtained, and from statistics of these differences a standard deviation (linearity) is obtained.

When the pattern drawing accuracy in the radial direction calculated in the evaluating step is more than 7 nm, the evaluated result is fed back to a step of setting EB drawing conditions in the EB drawing device, thereby adjusting the shift between drawing points caused by beam deflection of the EB drawing device and the shift caused by the feed per revolution of the stage of the EB drawing device.

### [Testing Device for Mold Structure]

Next, a testing device for carrying out the method for testing a mold structure of the present invention will be described.

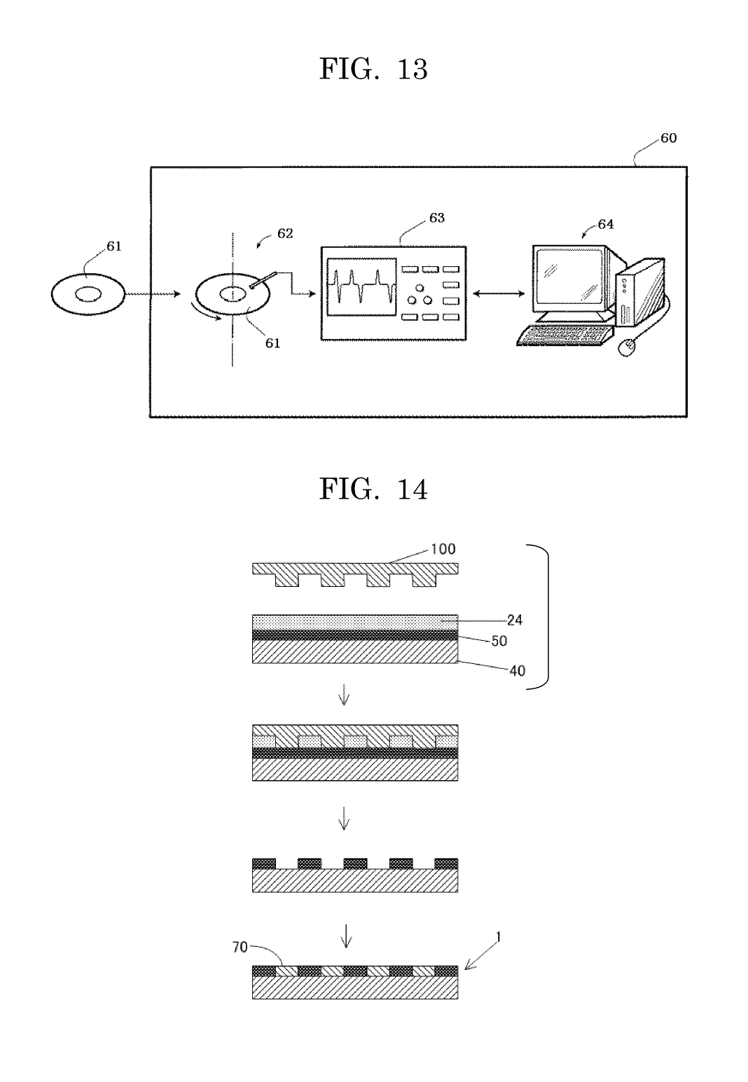

FIG. 13 is a schematic diagram showing an example of a testing device for the method for testing a mold structure of the present invention.

The testing device 60 is equipped with a spin-stand 62 and a digital storage oscilloscope 63 constituting a reproduction unit configured to obtain a reproduction signal pattern from a perpendicular magnetic recording medium (test medium to be transferred) 61, and a personal computer 64 constituting a evaluating unit to which the digital storage oscilloscope 63 is connected.

The personal computer 64 is provided with a software for controlling retrieval of a signal pattern from the oscilloscope 63, and obtaining the pattern drawing accuracy (linearity) in the radial direction from a servo pattern of the reproduction signal obtained by the oscilloscope 63.

Next, a method for testing a mold structure using the testing device 60 for a mold structure shown in FIG. 13 will be described.

Firstly, the test medium to be transferred 61 (hereinafter, may be referred to as “test medium”) is prepared, and a magnetic signal from a mold structure to be tested is magnetically transferred to the test medium 61 in the direction perpendicular to a surface of the test medium (recorded vertically) to obtain a perpendicular magnetic recording medium. Magnetic transfer in the direction perpendicular to the test medium (vertical recording) is performed using a known method in the art.

The perpendicular magnetic recording medium thus obtained is set in the spin-stand 62 for evaluating electromagnetic conversion property.

In a mold structure used for producing a discrete track medium (DTM) as shown in FIG. 9, 50 tracks or more of the magnetic signal of servo data transferred onto the perpendicular magnetic recording medium using a magnetic head having a width which is smaller than the track width so as to obtain a reproduction signal, and the reproduction signal is retrieved in the digital oscilloscope 63.

A reproduction signal pattern retrieved in the digital oscilloscope 63 is further sent to the personal computer 64, in which the following processing was carried out.

Servo marks are detected from a servo frame, and a clock defined in a preamble is calculated every servo frame. According to the clock, a window of an address pattern is formed, and a signal is decoded to obtain address information. Moreover, a relative position from the burst area to the track center is calculated so as to obtain a PES value.

### <Method for Producing Magnetic Recording Medium>

Hereinafter, the method for producing a magnetic recording medium 1 (such as a discrete track medium or a bit patterned medium) using the mold structure 100 tested by the method for testing a mold structure of the present invention, will be described with reference to the drawings. Note that the method for producing the magnetic recording medium 1 using the mold structure tested by the method for testing a mold structure of the present invention may be a method other than the method described below as long as it uses the mold structure 100.

As shown in FIG. 14, a mold structure 100 is pressed against a substrate 40 of the magnetic recording medium 1 over which a magnetic layer 50 and an imprint resist layer 24 formed by applying an imprint resist liquid are formed in this order, so that a convexo-concave pattern formed in the surface of the mold structure 100 is transferred to the surface of the imprint resist layer 24.

Subsequently, using as a mask the imprint resist layer 24, to which convexo-concave patterns 110 and 120 (as shown in FIG. 8) formed in the surface of the mold structure 100 have been transferred, the substrate is selectively etched by RIE or the like to form in the magnetic layer 50 the convexo-concave patterns formed in the mold structure 100. Then, a nonmagnetic material 70 is embedded in concave portions, and the surface thereof is smoothed, on which a protective layer or the like is formed as necessary, thereby obtaining a magnetic recording medium 1.

### Examples

Hereinafter, Examples of the present invention will be described. However, the present invention will not be limited to these Examples.

### Example 1

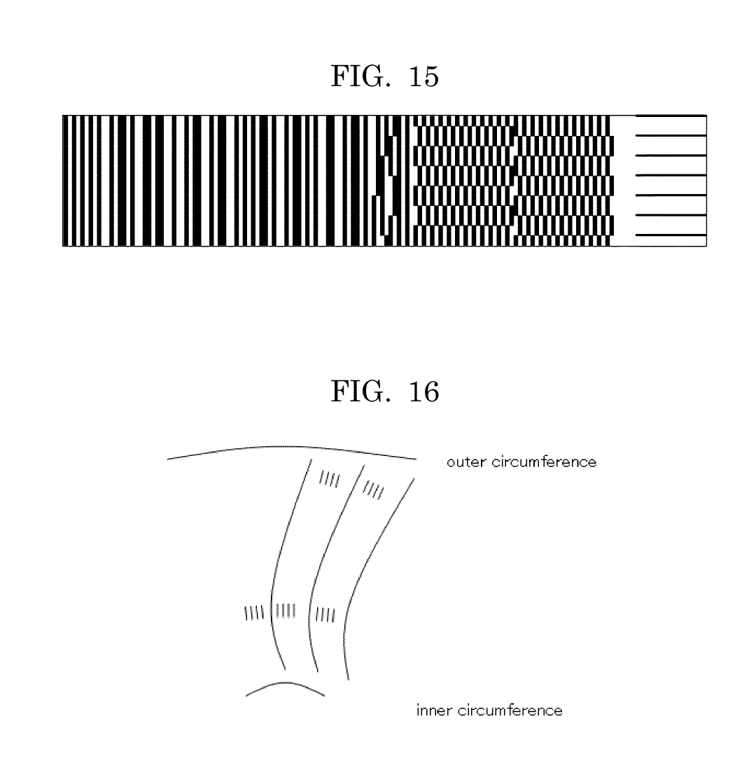

An electron beam resist was applied onto an 8 inch silicon (Si) wafer (original plate) by spin coating in the coating thickness of 100 nm so as to form a resist layer. On the resist layer formed over the Si original plate, a servo pattern including a servo address area and a burst area shown in FIG. 15 was drawn under several conditions using an EB drawing device, and by using the condition of the least shift of track intervals observed by SEM as a standard, the pattern drawing accuracy (linearity) in the radial direction was adjusted. By using the adjusted pattern as a standard, each pattern was drawn at a feed per revolution of a stage adjusted in the range from −6 to +6 of the EB drawing device so as to produce each original master having a pattern.

Each servo pattern was drawn in the same radii or a radius of 2 mm or less in an inner circumference, an intermediate circumference, and an outer circumference, as shown in FIG. 16. Specifically, each of the servo pattern was drawn near one radius of the circumference under 7 conditions which included a condition set in an approximately 0.2 mm width (1 mm in total).

Next, each pattern of the original master was replicated by Ni electroforming to obtain a mold structure, and a magnetic layer was provided on the mold structure. Then, magnetic information was magnetically transferred to the perpendicular magnetic recording medium by the magnetic transfer method.

The magnetic information transferred to the perpendicular magnetic recording medium was obtained in such a manner that 50 tracks or more of the magnetic signal of servo data transferred onto the perpendicular magnetic recording medium was electrically reproduced in a pitch of less than 1 track (Tr) by BIT-FINDER (manufactured by IMES Co., Ltd.) using a magnetic head (having a reading head width of 80 nm) so as to obtain a reproduction signal.

From the obtained date, a Position Error Signal (PES) value was calculated every servo frame, and a difference of the PES value calculated in the radial direction with respect to the feed per revolution of a piezoelectric stage of the BIT-FINDER (manufactured by IMES Co., Ltd.) was obtained, and from statistics of these differences a standard deviation was obtained. The standard deviation obtained from the statistics was 3.3 nm.

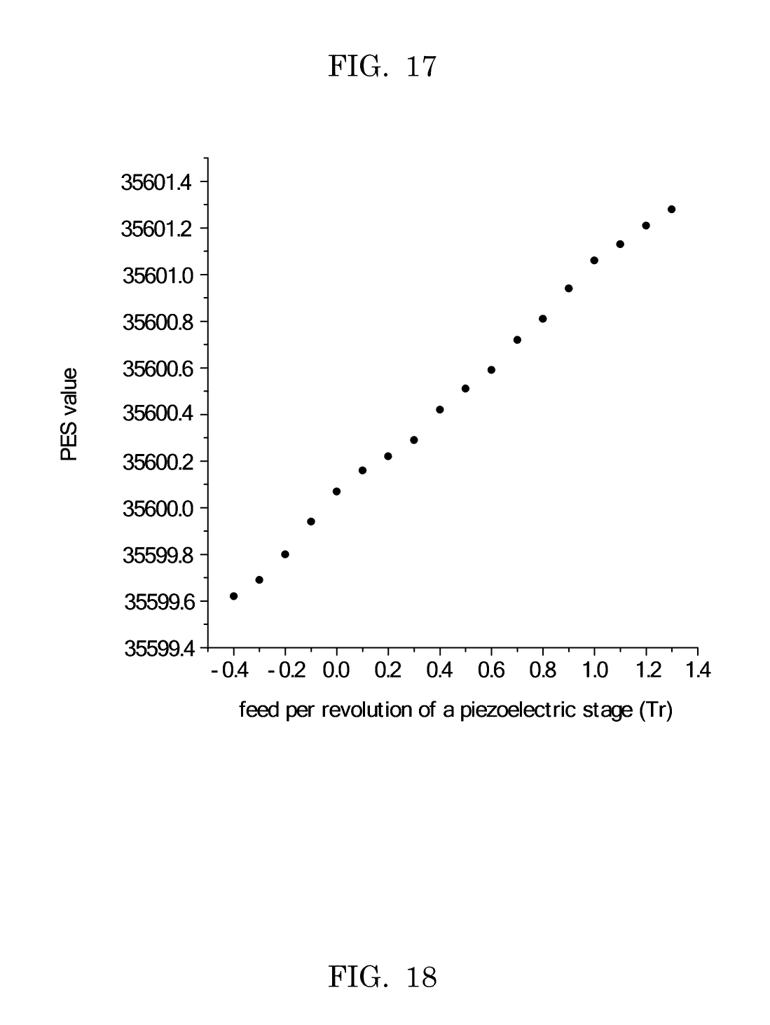

The profile was plotted by taking the feed per revolution of the stage of BIT-FINDER (manufactured by IMES Co., Ltd.) on X axis (Tr, 1 Tr=1 PES) and the PES value on Y axis, and the result shown in FIG. 17 was obtained.

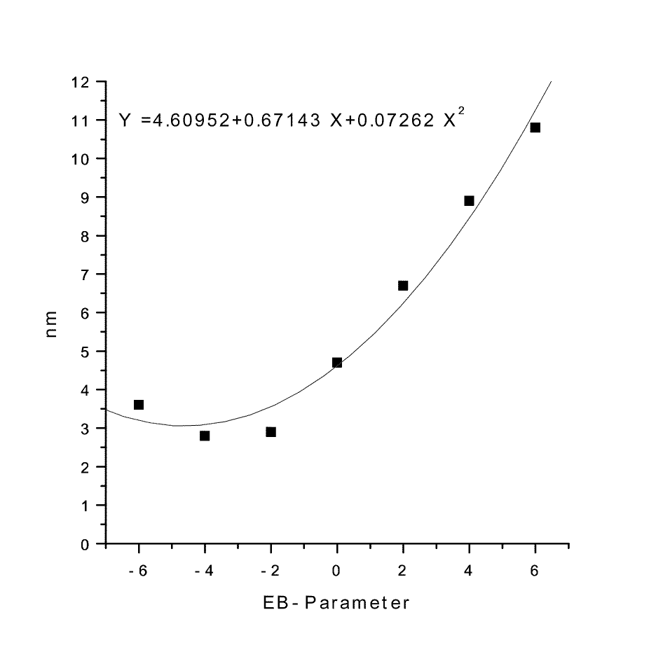

In FIG. 18, the profile was plotted by taking the EB parameter on X axis and the errors between track intervals on Y axis. Here, the EB parameter means a correction amount of the length of the stage with respect to a certain distance.

From the result of FIG. 18, it was found that the optimum value of the stage ranged from −4 to −3.

The feed per revolution of the stage in the EB drawing device was adjusted to the pattern drawing accuracy (linearity) of 3.3, and a pattern was formed. The errors between track intervals were 0.31 nm, 0.22 nm, 0.34 nm, 0.32 nm and 0.28 nm, and an average value was 0.29 nm.

### Comparative Example 1

When each original master was produced, a pattern was produced under the conditions of the feed per revolution of the stage of the EB drawing device adjusted by means of a SEM. The errors between track intervals were 3.5 nm, 7 nm, 8.4 nm, 14 nm and 0.5 nm, and an average value was 6.7 nm. The shifts widely varied.

The errors between track intervals in Comparative Example 1 was widely varied, compared to those in Example 1.

The method for testing the mold structure of the present invention can evaluate the accuracy (linearity) in the radial direction of a servo pattern by fine adjustment of a parameter of EB drawing, thereby rapidly and surely preventing production of defective products in the production of the mold structure.

What is claimed is:

1. A method for testing a mold structure comprising:
magnetically transferring a magnetic signal according to a concavo-convex pattern for a servo area in a mold structure to a perpendicular magnetic recording medium;
electrically reproducing 50 tracks or more of the magnetic signal of servo data transferred onto the perpendicular magnetic recording medium using a magnetic head so as to obtain a reproduction signal; and
calculating a pattern drawing accuracy in the radial direction from the reproduction signal so as to evaluate a performance of the mold structure,
wherein the mold structure comprises:
a disc-shaped base material; and
the concavo-convex pattern for the servo area and a concavo-convex pattern for a data area formed on a surface of the base material according to a desired design pattern, and
wherein the concavo-convex pattern for the servo area are aligned in the radial direction of the base material, and the concavo-convex pattern for the data area are aligned in the circumferential direction between the concavo-convex patterns for the servo area.

2. The method for testing a mold structure according to claim 1, wherein the pattern drawing accuracy in the radial direction is 7 nm or less.

3. The method for testing a mold structure according to claim 1, wherein a head width of the magnetic head is 50% or more to less than 100% of the track width.

4. The method for testing a mold structure according to claim 1, wherein when the pattern drawing accuracy in the radial direction is more than 7 nm, any of a beam deflection and a feed per revolution of a stage is adjusted in an electron beam drawing device in production of the mold structure.

5. A mold structure, comprising:
a disc-shaped base material; and
a concavo-convex pattern for a servo area and a concavo-convex pattern for a data area formed on a surface of the base material according to a desired design pattern,
wherein the concavo-convex pattern for the servo area are aligned in the radial direction of the base material, and the concavo-convex pattern for the data area are aligned in the circumferential direction between the concavo-convex patterns for the servo area, and
wherein the mold structure is tested by a method for testing a mold structure, the method comprising:
magnetically transferring a magnetic signal according to the concavo-convex pattern for the servo area in the mold structure to a perpendicular magnetic recording medium;
electrically reproducing 50 tracks or more of the magnetic signal of servo data transferred onto the perpendicular magnetic recording medium using a magnetic head so as to obtain a reproduction signal; and
calculating a pattern drawing accuracy in the radial direction from the reproduction signal so as to evaluate a performance of the mold structure.

6. The mold structure according to claim 5, wherein the pattern drawing accuracy in the radial direction is 7 nm or less.

7. A magnetic recording medium produced by using a mold structure tested by a method for testing a mold structure,
wherein the mold structure comprises:
a disc-shaped base material; and
a concavo-convex pattern for a servo area and a concavo-convex pattern for a data area formed on a surface of the base material according to a desired design pattern, and
wherein the concavo-convex pattern for the servo area are aligned in the radial direction of the base material, and the concavo-convex pattern for the data area are aligned in the circumferential direction between the concavo-convex patterns for the servo area, and
wherein the method for testing a mold structure comprises:
magnetically transferring a magnetic signal according to the concavo-convex pattern for the servo area in the mold structure to a perpendicular magnetic recording medium;
electrically reproducing 50 tracks or more of the magnetic signal of servo data transferred onto the perpendicular magnetic recording medium using a magnetic head so as to obtain a reproduction signal; and
calculating a pattern drawing accuracy in the radial direction from the reproduction signal so as to evaluate a performance of the mold structure.
